(19) United States
(12) Patent Application Publication
(10) Pub. No.: US 2026/0006127 A1
(43) Pub. Date: Jan. 1, 2026

(54) Agent Failback From Survivability Mode To Normal Mode In A Contact Center Service

(71) Applicant: Zoom Communications, Inc., San Jose, CA (US)

(72) Inventors: William Thomas Bernabe, Northborough, MA (US); Benjamin Joseph DeStephen, Hilliard, OH (US); Michael David O'Brien, Kirkland, WA (US); Brian David Wright, Murphys, CA (US)

(21) Appl. No.: 18/754,769

(22) Filed: Jun. 26, 2024

(51) Int. Cl. H04M 3/523; H04M 3/51

(52) U.S. Cl. CPC H04M 3/523; H04M 3/5175

(57) ABSTRACT

A survivability server associated with a contact center service determines that the contact center service operating in survivability mode is transitioned to a normal mode. The survivability server identifies an idle agent not engaged with an end user, the idle agent connected to the survivability server. The survivability server transmits a request to a device of the idle agent to connect to a central server associated with the contact center service. The survivability server identifies an engaged agent. The survivability server waits until the engaged agent becomes idle prior to transmitting a request to a device of the engaged agent to connect to the central server.

### FIELD

This disclosure generally relates to contact center services, and, more specifically, to transitioning a contact center service between normal and survivability modes.

### BRIEF DESCRIPTION OF THE DRAWINGS

This disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a contact center (CC) system.

FIG. 5 illustrates configurations of a survivable contact center service implemented by a system that implements a survivable contact center service at different points in time.

FIG. 6A illustrates an example of failing over into survivability mode.

FIG. 6B illustrates an example of falling back from survivability mode into normal mode.

FIG. 7A is a block diagram of example functionality of survivability CC.

FIG. 7B is a block diagram of example functionality of central CC.

FIG. 8 is a block diagram that illustrates an example of reconnecting a call from a central server to a survivability server.

FIG. 9 illustrates an example a mapping between a central workflow of a central CC and a survivability workflow of a survivability CC.

FIG. 10 is a flowchart of an example of a technique for transitioning agents from survivability mode to normal mode.

FIG. 11 is an example of a technique for contact center workflow mapping in survivability mode.

FIG. 12 is an example of a technique for queue management in a contact center service during survivability mode.

FIG. 13 is an example of a technique for transitioning queue management from a survivability server back to a central server in a contact center service.

FIG. 14 is an example of a technique for transitioning a contact center service from survivability mode back to normal mode.

### DETAILED DESCRIPTION

The use of contact center services by or for service providers is becoming increasingly common to address customer support requests over various modalities, including telephony, video, text messaging, chat, and social media. In one example, a contact center service may be implemented by an operator of a software platform, such as a unified communications as a service (UCaaS) platform or a contact center as a service (CCaaS) platform, for a customer of the operator. Users of the customer may engage with the contact center to address support requests over one or more communication modalities enabled for use with the contact center by the software platform. In another example, the operator of such a software platform may implement a contact center to address customer support requests related to the software platform itself.

During normal operations, a contact center service, facilitated by a software platform such as the CCaaS, operates seamlessly. Agents log into the software platform to handle end user interactions. End users initiate contact through various channels, such as telephone calls. Data may be gathered from a calling end user and/or accessed (e.g., retrieved) from one or more systems to inform the engagement, such as when the end user is connected to an agent. An end user may be placed in a queue, with their position determined by, for example, their purpose, the urgency of their request, and agent availability. The software platform, configured with routing algorithms, directs these calls to the most suitable agents.

It is desirable for CC services to maintain service continuity when their underlying software platforms become inaccessible. Ensuring persistent availability of a CC service maintains business operations and customer satisfaction. In this context, “survivability” refers to the ability to continue providing essential contact center services in situations where the software platform is deemed unavailable (such as due to disruptions or network outages). As such, the contact center service is said to operate in “normal mode” when the underlying software platform is deemed available and in “survivability mode” when the underlying software platform is deemed unavailable.

Conventional survivability solution are known in the context of telephony operations and involve deploying local, on-premise servers that take over telephony operations when a central telephony platform fails. In case of failures, telephony equipment, such as private branch exchange (PBX) systems or session initiation protocol (SIP) trunking gateways, are reconfigured to reroute calls locally (e.g., to an on-premise server), thereby maintaining operational continuity for post-inaccessibility received calls. SIP trunking is a technique of sending voice and other communications services over the internet, replacing traditional telephone lines by connecting a PBX directly to the internet via a SIP (Session Initiation Protocol) provider.

However, conventional telephony survivability solution fall short in the context of a CC service. For example, they fail to preserve queue positions or session data during transitions. This can lead to customer frustration, as callers may lose their place in the queue and potentially face long wait times again. Such disruptions significantly degrade the customer experience, underscoring the need for more robust solutions that ensure seamless service continuity of contact centers.

Implementations according to this disclosure address problems such as these via a survivability model that integrates both central (e.g., cloud-based) and local (e.g., on-premise) resources. The survivability model seamlessly transitions between the central and on-premise solutions during outages, ensuring the continuity of data sessions and queue positions. By employing intelligent synchronization techniques, customer interactions, regardless of the communication channel, are preserved and continued with minimal, if any, loss of context or disruption in service flow. This approach enhances the robustness of contact center operations, significantly improving the customer experience during and after network disruptions.

In some implementations, a survivability server associated with a contact center service receives, from a central server associated with the contact center service, data associated with a first workflow executed by the central server with respect to an end user connected to contact center service. That is, a device of the end user is connected to the contact center service via the central server. The survivability server determines that the central server is unavailable. In response to determining that the central server is unavailable, the survivability server identifies, based on the data, a second workflow to execute by the survivability server and executes the second workflow with respect to the end user.

In some implementations, a survivability server associated with a contact center service receives, from a central server associated with the contact center service, queue-related data. The survivability server receives a request to connect an end user to the contact center service. The survivability server identifies, based on the queue-related data, a queue position of the end user. The survivability server places the end user at the queue position in a queue constituted by the survivability server.

In some implementations, a survivability server associated with a contact center service determines that the contact center service operating in survivability mode is to be transitioned to a normal mode. The survivability server identifies an idle agent not engaged with an end user, the idle agent connected to the survivability server. The survivability server transmits a request to a device of the idle agent to connect to a central server associated with the contact center service. The survivability server identifies an engaged agent. The survivability server waits until the engaged agent becomes idle prior to transmitting a request to a device of the engaged agent to connect to the central server.

In some implementations, a central server associated with a contact center service receives queue-related data from a survivability server associated with the contact center service. The central server identifies an end user based on the queue-related data. The central server establishes a reconnection between a device of the end user and the contact center service. The central server places the end user at a position in a queue associated with the central server based on the queue-related data.

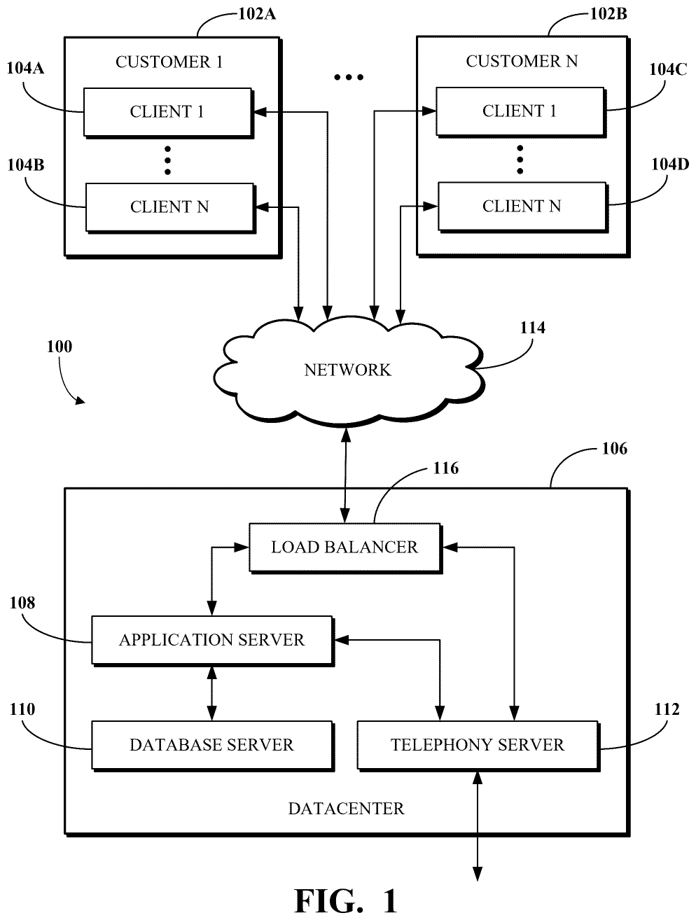

To describe some implementations in greater detail, reference is first made to examples of hardware and software structures used to implement a system for transitioning a contact center service between normal and survivability modes. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a SIP zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based PBX system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, an SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, an SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients. In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

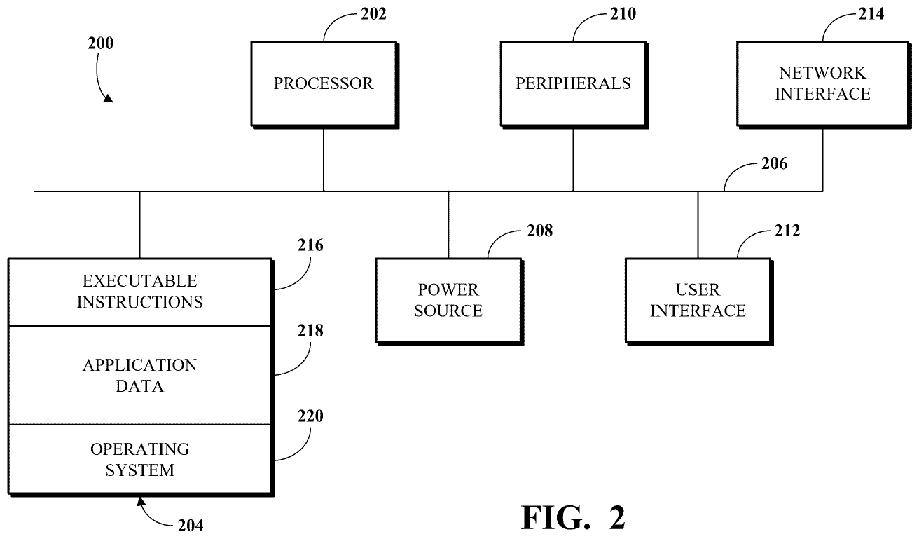

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid-state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

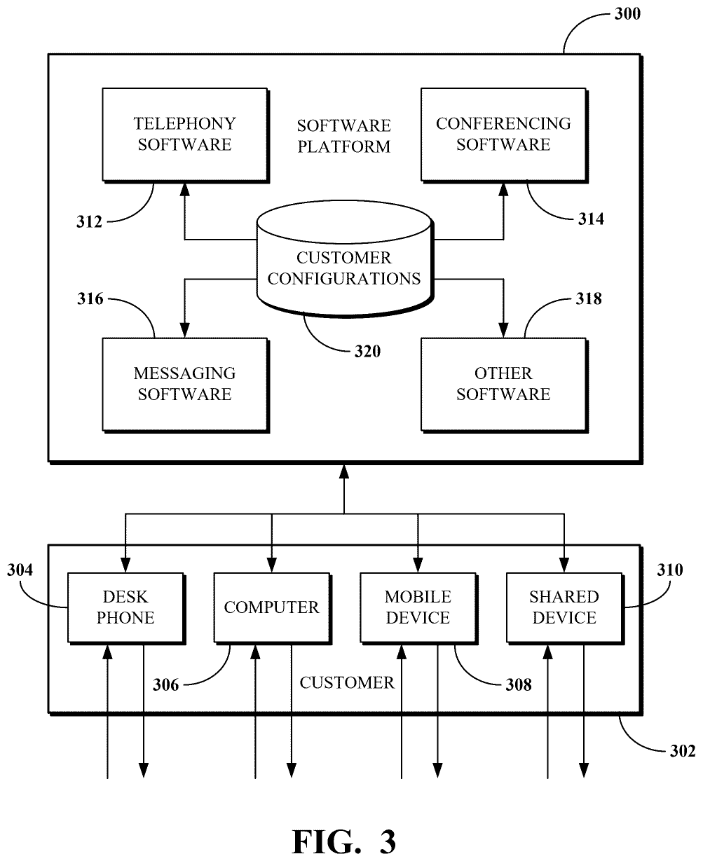

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a that is call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for transitioning a contact center service between normal and survivability modes.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

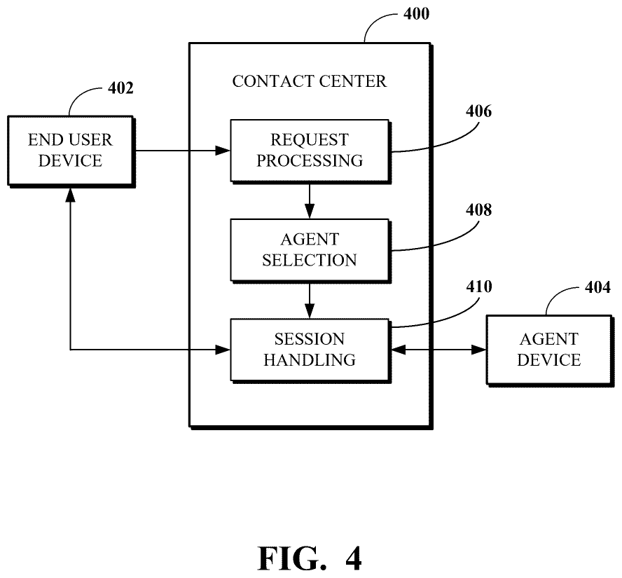

FIG. 4 is a block diagram of an example of a contact center system. A contact center 400, which in some cases may be implemented in connection with a software platform (e.g., the software platform 300 shown in FIG. 3), is accessed by a user device 402 and used to establish a connection between the user device 402 and an agent device 404 over one of multiple modalities available for use with the contact center 400, for example, telephony, video, text messaging, chat, and social media. The contact center 400 is implemented using one or more servers and software running thereon. For example, the contact center 400 may be implemented using one or more of the servers 108 through 112 shown in FIG. 1, and may use communication software such as or similar to the software 312 through 318 shown in FIG. 3. The contact center 400 includes software for facilitating contact center engagements requested by user devices such as the user device 402. As shown, the software includes request processing software 406, agent selection software 408, and session handling software 410.

The request processing software 406 processes a request for a contact center engagement initiated by the user device 402 to determine information associated with the request. The request may include a natural language query or a request entered in another manner (e.g., “press 1 to pay a bill, press 2 to request service”). The information associated with the request generally includes information identifying the purpose of the request and which is usable to direct the request traffic to a contact center agent capable of addressing the request. The information associated with the request may include information obtained from a user of the user device 402 after the request is initiated. For example, for the telephony modality, the request processing software 406 may use an interactive voice response (IVR) menu to prompt the user of the user device to present information associated with the purpose of the request, such as by identifying a category or sub-category of support requested. In another example, for the video modality, the request processing software 406 may use a form or other interactive user interface to prompt a user of the user device 402 to select options which correspond to the purpose of the request. In yet another example, for the chat modality, the request processing software 406 may ask the user of the user device 402 to summarize the purpose of the request (e.g., the natural language query) via text and thereafter process the text entered by the user device 402 using natural language processing and/or other processing.

The session handling software 410 establishes a connection between the user device 402 and the agent device 404, which is the device of the agent selected by the agent selection software 408. The particular manner of the connection and the process for establishing same may be based on the modality used for the contact center engagement requested by the user device 402. The contact center engagement is then facilitated over the established connection. For example, facilitating the contact center engagement over the established connection can include enabling the user of the user device 402 and the selected agent associated with the agent device 404 to engage in a discussion over the subject modality to address the purpose of the request from the user device 402. The facilitation of the contact center engagement over the established connection can use communication software implemented in connection with a software platform, for example, one of the software 312 through 318, or like software.

The user device 402 is a device configured to initiate a request for a contact center engagement which may be obtained and processed using the request processing software 406. In some cases, the user device 402 may be a client device, for example, one of the clients 304 through 310 shown in FIG. 3. For example, the user device 402 may use a client application running thereat to initiate the request for the contact center engagement. In another example, the connection between the user device 402 and the agent device 404 may be established using software available to a client application running at the user device 402. Alternatively, in some cases, the user device 402 may be other than a client device.

The agent device 404 is a device configured for use by a contact center agent. Where the contact center agent is a human, the agent device 404 is a device having a user interface. In some such cases, the agent device 404 may be a client device, for example, one of the clients 304 through 310, or a non-client device. In some such cases, the agent device 404 may be a server which implements software usable by one or more contact center agents to address contact center engagements requested by contact center users. Where the contact center agent is a non-human, the agent device 404 is a device that may or may not have a user interface. For example, in some such cases, the agent device 404 may be a server which implements software of or otherwise usable in connection with the contact center 400.

Although the request processing software 406, the agent selection software 408, and the session handling software 410 are shown as separate software components, in some implementations, some or all of the request processing software 406, the agent selection software 408, and the session handling software 410 may be combined. For example, the contact center 400 may be or include a single software component which performs the functionality of all of the request processing software 406, the agent selection software 408, and the session handling software 410. In some implementations, one or more of the request processing software 406, the agent selection software 408, or the session handling software 410 may be comprised of multiple software components. In some implementations, the contact center 400 may include software components other than the request processing software 406, the agent selection software 408, and the session handling software 410, such as in addition to or in place of one or more of the request processing software 406, the agent selection software 408, and the session handling software 410.

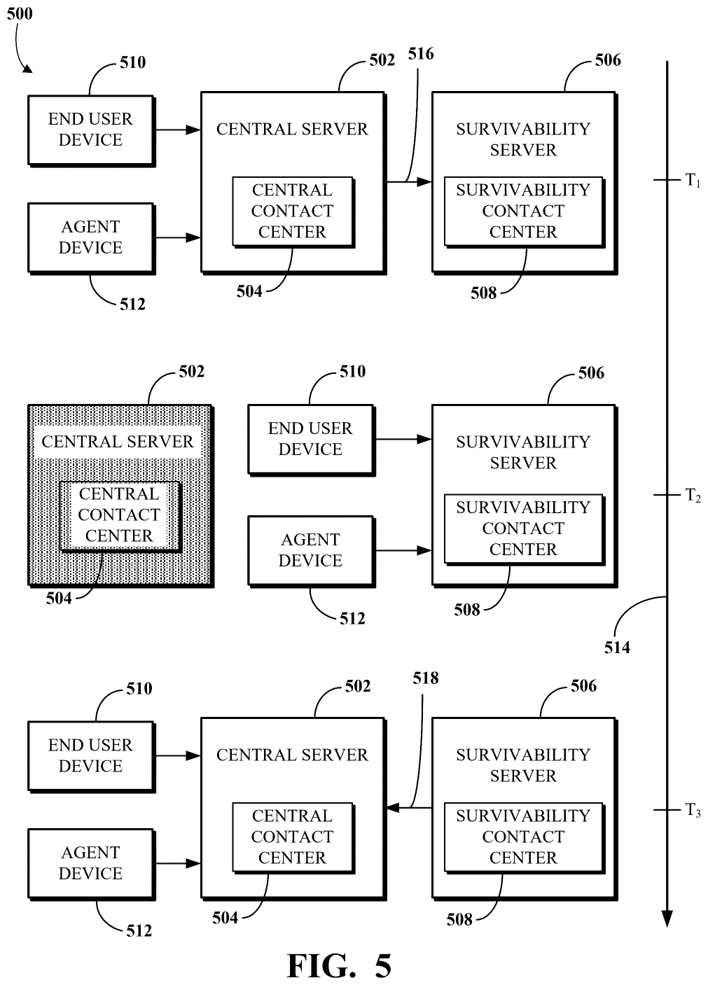

FIG. 5 illustrates configurations of a survivable contact center service implemented by a system 500 that implements a survivable contact center service at different points in time. In this context, “survivable” refers to the ability of the system 500 to provide the contact center service (e.g., maintain essential operations and customer service continuity) during failures or disruptions of a central server 502 or a central CC 504. The system 500 includes the central server 502, which includes the central CC 504, and a survivability server 506, which includes a survivability CC 508. In actual implementations, and as described above, the central server 502 may be a cluster of servers and the survivability server 506 can be a cluster of servers.

The central server 502 and the survivability server 506 can each include any number of constituent servers, each with one or more processors and memories. Statements herein such as “the server (e.g., the central server 502 or survivability server 506) performs a first and a second action/operation” mean that either one constituent server performs both actions/operations, or one constituent server performs the first action/operation, and another constituent server performs the second action/operation. Similarly, the central CC 504 and the survivability CC 508, which are software components, may each comprise several software modules (or tools) distributed across multiple constituent servers. Therefore, statements herein such as “the CC (e.g., the central CC 504 or the survivability CC 508) performs a first and a second action/operation” should be understood to mean that either one module implements both actions/operations, or one module on one constituent server performs the first action/operation while another module on a different constituent server performs the second action/operation. Additionally, statements such “the server (e.g., the central server 502 or survivability server 506) performs an action/operation” should be understood to mean that the CC (e.g., the central CC 504 or the survivability CC 508) therein performs the action/operation and vice versa.

FIG. 5 illustrates a very simplified view of the system 500. In actual implementations, and as described herein, the system 500 may include one or more of an SBC, a PBX, a PSTN, and other components that facilitate connecting, via one or more modalities, an end user device 510, which can be the end user device 402 of FIG. 4, to an agent device 512, which can be the agent device 404 of FIG. 4. While the disclosure is mainly described with respect to “calls,” which implies telephony connections between end users and the contact center service, the disclosure is not limited to the telephony modality for connecting to the contact center service.

The central server 502 can be a cloud-based server. The survivability server 506 can be an on-premises server. A cloud-based server refers to a server hosted in a datacenter and accessible over the internet, providing scalable and flexible resources. The central server 502 can be deployed in the datacenter 106 of FIG. 1. An on-premises server refers to a server that may be physically located within the premises of an organization or otherwise under the control of the organization offering direct control over hardware and software resources.

While both of the central CC 504 and the survivability CC 508 may generally implement the functions described with respect to FIG. 4 (e.g., request processing, agent selection, and session handling), the central CC 504 may include advanced call routing, customer data integration, and other integrations with other systems, such as a customer relationship management (CRM) system. The central CC 504 may provide (such as via integrations) full-featured services with access to various cloud resources, such as databases, web-services, and external systems. Agents connect (via their agent devices) to the central server 502 under normal conditions to handle interactions with end users.

The survivability server 506 is a local, on-premises system configured to take over providing contact center services when the central server 502 becomes (e.g., is determined to be) unavailable. The survivability CC 508 may implement a subset of the features of the central CC 504, ensuring that essential functions (e.g., call routing and queue management) remain operational. The survivability CC 508 locally stores data regularly received from the central CC 504. The data enable the survivability CC 508 to continue serving end users when the central CC 504 is unavailable.

The survivability CC 508 may receive the data from the central CC 504 through multiple mechanisms to ensure that the survivability CC 508 is up-to-date and capable of taking over as seamlessly as possible during periods of unavailability of the central CC 504. Data can be received via polling, where the survivability CC 508 periodically requests updates from the central CC 504. Alternatively, or additionally, the central CC 504 can push updates to the survivability CC 508 on a regular basis or whenever there are changes in the queue data maintained by the central CC 504. Data may be sent to the survivability CC 508 whenever new information about an end user is collected or becomes available. When there are no data changes to transmit to the survivability CC 508, the central CC 504 may still transmit a message (e.g., a heartbeat signal) to the survivability CC 508 indicating that it is still available.

The central server 502 can be determined to be unavailable when the survivability server 506 no longer receives data or heartbeat signals from the central server 502. If the survivability CC 508 does not receive regular data updates or heartbeat signals from the central CC 504, the survivability CC 508 may send ping requests or similar signals to determine the availability of the central CC 504. Unavailability can be determined if the central CC 504 fails to respond to such requests within a specified timeframe.

The central server 502 can become unavailable due to any number of reasons or triggers. To illustrate, the central server 502 may be determined to be unavailable due to network failures, denial of service attacks on the central server 502, or during periods of maintenance of the central server 502. Other reasons for unavailability include hardware failures within the datacenter, software bugs causing system crashes, power outages at the datacenter, natural disasters affecting the datacenter, and misconfigurations during updates or deployments. Other triggers, such as significant network latency or complete network outages, may also cause the survivability CC 508 to take over operations, ensuring continuous contact center service delivery. In some circumstances, the central CC 504 may implicitly or explicitly transmit signals or commands to the survivability CC 508 indicating that it is unavailable. For example, by intentionally stopping transmission of heartbeat signals, the survivability CC 508 implicitly indicates that it no longer available. For example, the central CC 504 may transmit an explicit status to the survivability CC 508 indicating that it unavailable.

At time T₁, the central server 502 is fully operational. Agents, such as an agent associated with the agent device 512, connects to (e.g., logs into) the central CC 504. End user devices 510 and agent devices 512 are connected to the central server 502, which handles all contact center function, such as described with respect to FIG. 4. As such, one or more agents may be engaged with respective one or more end users while other end users (e.g., other end user devices) may be placed in or more queues awaiting available agents. That is, end users submit contact center requests (e.g., initiate contact with the contact center service) via various communication channels, such as a voice channel (e.g., a telephone call), an audio-visual channel (e.g., a video-based session), or a text-based channel (e.g., a chat channel). The central server 502 (i.e., the central CC 504) may collect data from a calling end user and/or may retrieve end user data from integrated databases and, if no agent is available, places the end user in a queue based on the nature of their request and agent availability.

The central CC 504 facilitates connections and interactions between users and agents. Users initiate contact center engagements through their devices by submitting a contact center request. These requests are placed in queues associated with groups of agents. Typically, queues operate on a first-come-first-served basis, also known as a first-in-first-out (FIFO) queue. However, in certain situations, prioritized users are not added to the queue in the order their requests are received. Instead, these users, identified as being associated with prioritized routing, are placed in the queue based on their associated priority levels. Connecting an end user to an agent establishes a private virtual session between their respective devices. When an agent device and an end user device are connected to establish a private session, the agent is said to be engaged with the end user or that the agent and the end user are involved in an “engagement.”

As indicated by an arrow 516, the central server 502 regularly transmits data to the survivability server 506. More specifically, the central CC 504 transmits the data to the survivability CC 508. The data enables the survivability server 506 to continue to provide contact center services if the central server 502 becomes unavailable. The data may include workflow-related data (such as routing information), queue-related data (such as queue positions of end users), and/or customer interaction data. The data include data (i.e., “queued-user data”) related to queued end users and data (i.e., “engaged-user data”) related to the end users being serviced by (e.g., engaged with) agents.

At time T₂, the central server 502 is determined to be unavailable. That the central server 502 is unavailable includes that the central CC 504 is unavailable and vice versa. End user devices 510 and agent devices 512 are redirected to connect (e.g., are reconnected) to the contact center service via the survivability server 506. The survivability CC 508 within the survivability server 506 takes over the contact center operations, ensuring continuous service for end users and agents. The data received from the central CC 504 is used by the survivability CC 508 to maintain ongoing (e.g., queuing) operations. These data ensure that end user contact center requests (e.g., calls) are handled with minimal, if any, interruption and that agents have the necessary information to continue providing support as seamlessly as possible.

The survivability CC 508 can use the data to reconstitute queues. In some implementations, the data can be used to contact (e.g., initiate callbacks to) end users and place them in queues based on the queue-related data. In some implementations, if an end user contacts the contact center service (e.g., submits a contact center request), the workflow-related data and/or the queue-related data can be used to determine whether the end user was connected to the CC service when the central server 502 became unavailable. If so, the queue-related data can be used to place the user at the corresponding position in the queue of the survivability CC 508. When an end user is connected to an agent, the customer interaction data received from the central CC 504 can be provided to the agent (e.g., displayed at the agent device).

At time T₃, the central server 502 is restored (e.g., becomes available again). End user devices 510 and agent devices 512 are reconnected to the central server 502, which resumes handling the contact center functions. The survivability server 506 returns to its standby mode, having maintained service continuity during the central server's downtime. As illustrated by an arrow 518, the survivability CC 508 transmits data to the central CC 504 enabling the central CC 504 to reconstitute the queues. Only data related to queued end users (i.e., queued-user data) is transmitted to the central CC 504. Any end users engaged with agents continue to be serviced by the agents via the survivability CC 508. As agents become inactive, they are reconnected (or prompted to reconnect) to the central CC 504.

To summarize, while the central CC 504 is available, end users contacting (e.g., submitting contact center requests to) the contact center service may be queued at the central CC 504 and engaged with agent devices connected to the central CC 504. The central CC 504 may support query options such as CRM, Direct Inward Dialing (DID) lookup, customer input/validation, and numerous possibilities. When the central CC 504 becomes unavailable, the system 500 facilitates transitioning the queue and its details to the survivability CC 508. That is, the system 500 facilitates re-queuing users queued at the central CC 504 at the survivability CC 508; and facilitates re-engaging users engaged with agents via the central CC 504 at the survivability CC 508. As further described herein, re-engaging users at the survivability CC 508 may include queuing at least some of these engaged users at the survivability CC 508, such as due to the unavailability of sufficient agents at the survivability CC 508. Once the central CC 504 becomes available again, the system 500 facilitates re-queueing users queued at the survivability CC 508 at the central CC 504.

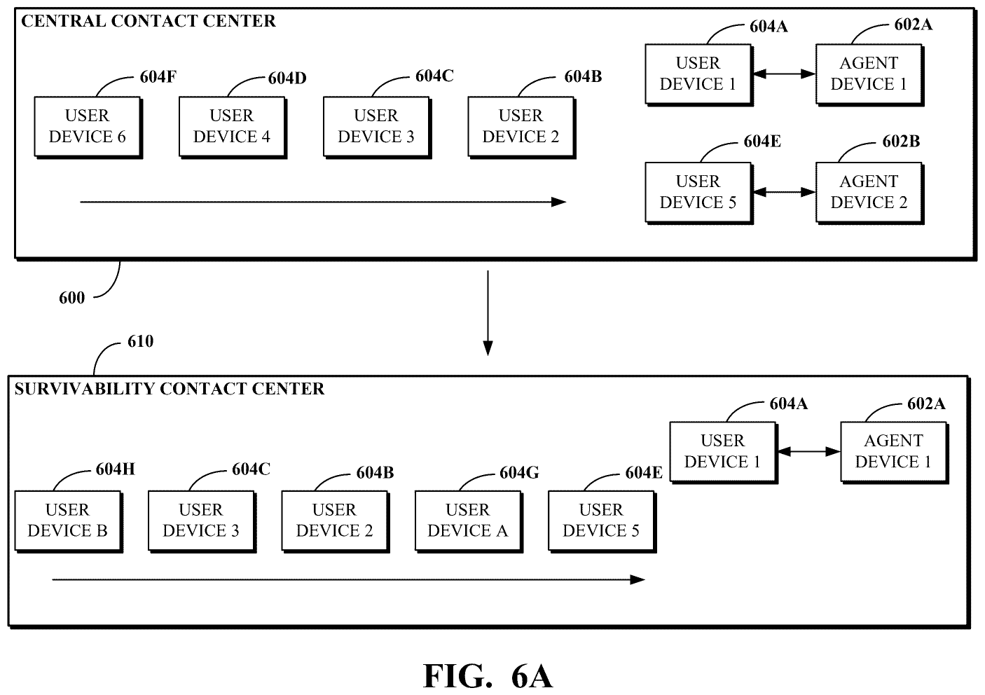

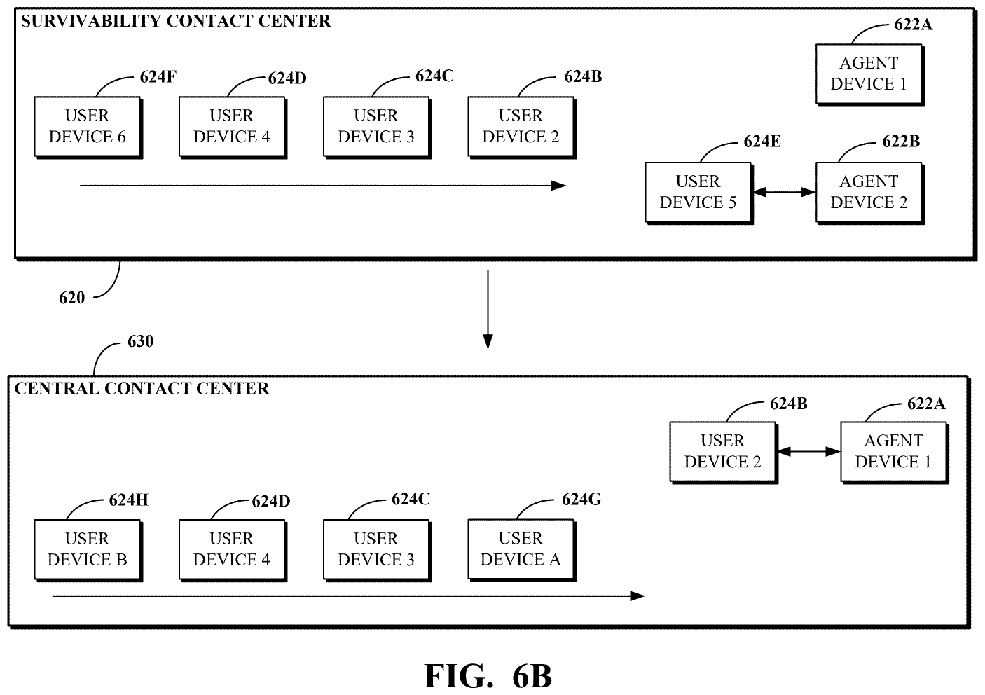

FIG. 6A illustrates an example of failing over into survivability mode. That is, FIG. 6A illustrates an example of transitioning users from a central CC, such as the central CC 504 of FIG. 5 to a survivability CC, such as the survivability CC 508 of FIG. 5. A block 600 illustrates end users connected to the central CC at a moment immediately prior to the central CC becoming unavailable; and a block 610 illustrates, with respect to those users, operations of the survivability CC in response to the central CC becoming unavailable.

A user queued at the central CC 504 may be referred to as a “centrally queued user.” A user queued at the survivability CC 508 may be referred to as a “survivably queued user.” An agent (agent device) connected at the central CC 504 may be referred to as a “centrally connected agent (agent device).” An agent (agent device) connected to the survivability CC 508 may be referred to as a “survivable agent (agent device).”

For simplicity of explanation, only two agents and one queue are shown and described. However, the disclosure is not so limited. Many more agents may be available in the contact center service and the central CC may implement many more queues. A contact center service may implement one or more queues for incoming requests, referred to as “contact center requests.” These requests are placed in queues where they wait until an agent becomes available. For brevity, the disclosure herein may include statements such as “an end user is placed in a queue.” Such statements should be understood to include that “a contact center request received from the end user is placed in the queue” or that whatever is added to the queue includes one or more identifiers of the end user, the device of the end user, or the contact center request. Agents, often organized into groups based on different criteria (e.g., skills, locations, or expertise levels), are assigned to specific queues. The queue system of the contact center service manages and prioritizes requests, ensuring they are handled efficiently. Routing may rely on information provided by users, such as responses to an IVR menu. Routing may also rely on prior interactions and/or data obtained from systems within or external to the contact center service. This information helps direct requests to the appropriate queue or agent.

The block 600 illustrates that two agents, Agent 1 (associated with an agent device 602A) and Agent 2 (associated with an agent device 602B), are available (are connected to the central CC) to provide contact center services. As such, Agent 1 and Agent 2 are centrally connected agents. User 1 through User 6 (associated with user devices 604A through 604F, respectively) are connected to the central CC. User 1 and User 5 are engaged with agents Agent 1 and Agent 2, respectively. The order of arrival of these users at the central CC is 604A to 604F. FIG. 6A illustrates that the central CC determined that User 5 (associated with the user device 604E) is associated with prioritized routing. As such, User 5 is connected to an agent ahead of other users from whom contact center requests were received prior to User 5.

As mentioned above, the central CC regularly transmits queued-user data and engaged-user data to the survivability CC. For example, the queued-user data may include that User 2, User 3, User 4, and User 6 are currently queued, in that order. The queued-user data may include an identifier for each of the users. The identifier may be a username, a telephone number, or any other data usable to identify the user. Such an identifier can be used for initiating contact (e.g., calling back) the user or for recognizing the user if the user re-connects to (e.g., calls back into) the contact center service (e.g., into the survivability CC). The queued-user data may include queue option selections of the users (e.g., whether the user selected 1 to pay a bill or 2 to request service). The queue option selections can be any data provided by the user and that is usable by the central CC in routing the user to a queue or to an agent. The queued-user data may include whether the users are associated with prioritized routing and the queues they are associated with. The engaged-user data includes similar data to the queued-user data and additionally include identifiers of the agents users are engaged with.

Block 610 illustrates that the central CC is determined to have become unavailable, and that the survivability CC is now providing contact center services. The block 610 illustrates that Agent 1 (e.g., the agent associated with the agent device 602A) is now connected to the survivability CC but that Agent 2 (e.g., the agent associated with the agent device 602B) is not connected to the survivability CC. As such, Agent 1 is now a survivable agent.

In some implementations, the survivability CC may initiate a process of re-contacting the end users who were engaged and queued at the central CC based on the queued-user data and the engaged-user data. In other implementations, the survivability CC may wait for users to re-contact the contact center service. In either case, the survivability CC places those users at appropriate positions in the queue(s).

The block 610 illustrates that User 1 is reconnected to Agent 1 and that User 5 is placed at the head of the queue since User 5 was an engaged user but there is no currently available agent to continue the engagement. User 4 is not in the queue because either User 4 did re-contact the call center service or an attempt to connect with User 4 was unsuccessful. The order of User 2 and User 3 is preserved. While in survivability mode, User A (associated with a user device 604G) and User B (associated with a user device 604H) arrive. That is, the contact center service receive contact center requests from devices associated with User A and User B. The survivability CC may determine that User A is associated with prioritized routing. Thus, User A is placed after User 5 in the queue. Arriving User B is placed at the tail of the queue.

FIG. 6B illustrates an example of falling back from survivability mode into normal mode. That is, FIG. 6B illustrates an example of transitioning users from a survivability CC, such as the central CC 504 of FIG. 5 to a central CC, such as the survivability CC 508 of FIG. 5. A block 620 illustrates end users connected to the survivability CC at a moment immediately prior to the central CC becoming available; and a block 630 illustrates, with respect to those users, operations of the central CC in response to the central CC becoming available.

The central CC may transmit a heartbeat signal to the survivability CC indicating that the central CC has become available. Alternatively, the survivability CC may regularly transmit ping requests to the central CC. When the survivability CC receives a response to the ping request, the central CC can be determined to be available. In another example, upon becoming available, the central CC may transmit a request for queued-user data to the survivability CC.

The block 620 illustrates that two agents, Agent 1 (associated with an agent device 622A) and Agent 2 (associated with an agent device 622B), are available (are connected to the survivability CC) to provide contact center services. At the time that the central CC becomes available, Agent 1 is not engaged with any user; but Agent 2 is engaged with User 5 (e.g., the user associated with user device 624E), who was determined to be associated with prioritized routing. Users 2, 3, 4, and 6 (associated with user devices 624B, 624C, 624D, and 604F, respectively), also referred to as survivably queued users, are connected to and queued at the survivability CC. The order of arrival of these users at the central CC is 604A to 604F.

Block 630 illustrates that the central CC is now providing contact center services. The central CC reconstitutes the queue(s) based on queued-user data received from the survivability CC. Any agents connected to the survivability CC and engaged with users continue those engagements to completion. However, any queued users at the survivability CC are transitioned to the central CC. As such, since Agent 1 is not engaged with any users, Agent 1 (e.g., the agent device 622A) is disconnected from the survivability CC and re-connected to the central CC.

At least some of the users queued at the survivability CC are re-queued at the central CC in the order that they were queued at the survivability CC. To illustrate, Users 2, 3, 4 and re-queued in that order. However, User 6 is not shown in the block 630 since User 6 did not reconnect or could not be re-contacted by the central CC. Since Agent 1 is available, User 2 is routed to Agent 1. That is, a session is established between the agent device 622A and the user device 624B. The block 630 further illustrates that User A and User B arriving at the contact center service after the central CC became available again. That a user arrives at the contact center service means that a contact center request is received from a device of that user. The central CC determines that User A is associated with prioritized routing, but that User B is not. As such, User A is placed at the head of the queue and User B is placed at the tail of the queue.

In some implementations, to cause a user to be reconnected to the central CC, the survivability CC may transmit a message to the user indicating that the user will be disconnected and directing the user to reconnect again to the contact center service. When the user reconnects, the central CC recognizes the user and places the user at the right position in the appropriate queue based on the queued-user data received from the survivability CC.

In some implementations, the contact center service (in at least one of the survivability mode or the normal mode) may also support automatic call-back functionality. For example, when falling into survivability mode, the survivability CC can initiate outbound calls to the end users who were disconnected due to the unavailability of the central CC. Upon transitioning back to normal mode, the central CC can initiate callbacks to those end users who were queued at the survivability CC. Additionally, users may be provided with estimated wait times and updates during the reconnection process to keep them informed and reduce frustration.

In some implementations, users queued at the survivable CC are not re-queued at the central CC. That is, at least some agents connected to the survivable CC continue to be connected to the survivable CC to service users queued at the survivability CC. When the queue at the survivable CC (i.e., the “survivability queue”) is drained (e.g., is empty), then the remaining agents can be reconnected to the central CC. In such situations, while there may be users in the survivability queue, no new users are added to the survivability queue. Rather, new users are added to a queue at central CC. That is, while users may be queued at both of the survivability CC and the central CC, new users are queued at only one the central CC. In some implementations, users who have waited for more than a threshold amount of time at the survivability CC are not evacuated to the central CC. Rather, they will continue to be queued at and serviced at the survivability CC. The threshold amount of time may be a pre-configured value (e.g., 15 minutes). The threshold amount of time may be based on an average queue time received from the central CC.

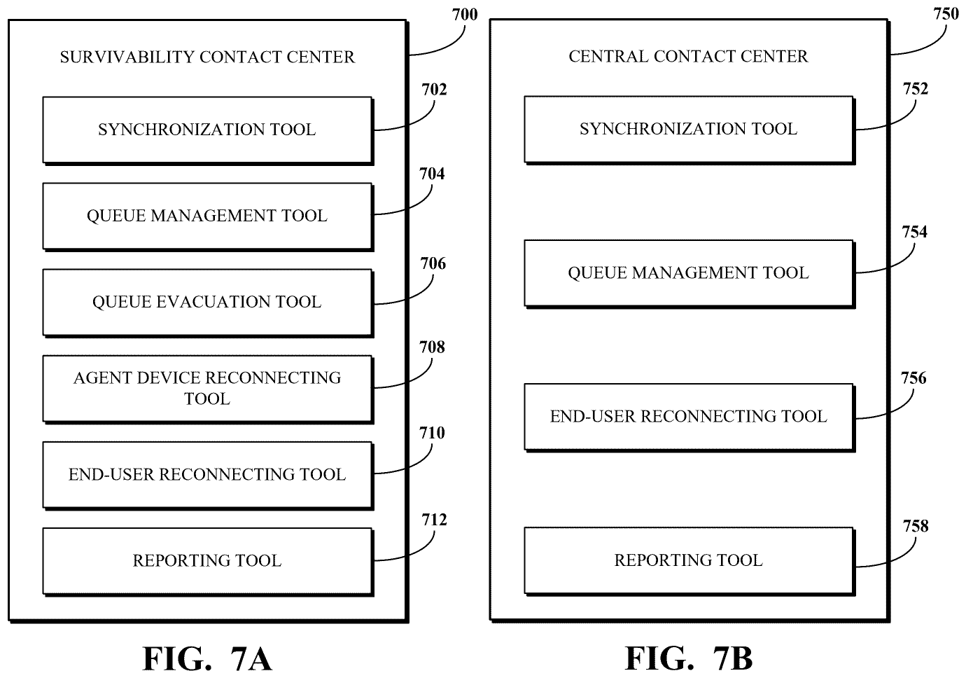

FIG. 7A is a block diagram of example functionality of survivability CC 700, which may be, for example, survivability CC 508 of FIG. 5. The survivability CC 700 includes tools, such as programs, subprograms, functions, routines, subroutines, operations, executable instructions, and/or the like for, inter alia and as further described below, facilitating transitioning centrally queued or centrally engaged users to become survivably queued or survivably engaged users when a central CC becomes unavailable and to facilitate transitioning survivably queued users to become centrally queued user when the central CC is determined to be available again.

At least some of the tools of survivability CC 700 can be implemented as respective software programs that may be executed by one or more computing devices, such as the computing device 200 of FIG. 2. A software program can include machine-readable instructions that may be stored in a memory such as the memory 204, and that, when executed by a processor, such as processor 202, may cause the computing device to perform the instructions of the software program.

As shown, the survivability CC 700 includes a synchronization tool 702, a queue management tool 704, a queue evacuation tool 706, an agent device reconnecting tool 708, an end-user reconnecting tool 710, and a reporting tool 712. In some implementations, the survivability CC 700 can include more or fewer tools. In some implementations, some of the tools may be combined, some of the tools may be split into more tools, or a combination thereof.

The synchronization tool 702 is configured to facilitate seamless operation and data consistency between the central CC, such as the central CC 750 of FIG. 7B and the survivability CC 700.

The synchronization tool 702 continuously receives data from the central CC, including one or more of workflow-related data, queue-related data, or customer interaction data. Workflow-related data may include routing information and/or agent availability. Queue-related data may include the queue positions of end users. Customer interaction data may include details of ongoing and/or past interactions. The synchronization tool 702 can use the received data to ensure that all user engagements can be resumed as seamlessly as possible, if interrupted. The synchronization tool 702 can use the received data to requeue users based on their queue positions at the central CC.

The synchronization tool 702 is also configured to determine that the central CC has become unavailable. In an example, the synchronization tool 702 actively monitors heartbeat signals or regular data updates from the central CC. If these signals or updates are not received within a specified timeframe, the synchronization tool 702 determines that the central CC is unavailable. This determination can also involve sending ping requests to the central CC; failure to receive a response confirms the central CC's unavailability.

Upon determining the unavailability of the central CC, the synchronization tool 702 can cause the activation of the operational capabilities of the survivability CC 700. That is, the contact center service enters survivability mode when the central CC is determined to be unavailable. The synchronization tool 702 utilizes the last received data to maintain ongoing operations.

The synchronization tool 702 can identify when the central CC becomes available again. The synchronization tool 702 may determine the availability of the central CC through renewed heartbeat signals or successful ping responses. The synchronization tool 702 may receive explicit status information from the central CC indicating that that the central CC is available. The synchronization tool 702 then synchronizes the survivable queue data back to the central CC. The data synchronized includes queue positions, new customer interaction data, and any changes in workflow-related data that occurred while the survivability CC 700 was active (i.e., while the contact center service was in survivability mode). As such, the central CC can be updated with the latest operational state and can resume normal operations with minimal, if any, service disruption.

The queue management tool 704 is configured to manage queues during failover operations (e.g., in the survivability mode). When a contact center request is received and the end user is identified as a reconnecting end user, as described with respect to the end-user reconnecting tool 710, the queue management tool 704 uses the data received from the central CC to determine an appropriate position for the end user in a queue. As such, the end user can be reinserted into the queue at the correct position, maintaining their priority and minimizing any disruption to their service experience. A reconnecting end user is one that was connected to the central CC but from whom a contact center request is received while the contact center service is in survivability mode. As further described herein, that a contact center request is received from a reconnecting end user includes that the contact center service initiated a reconnection of (e.g., a callback to) the end user.

The queue management tool 704 also uses the data received from the central CC to identify a most suitable agent for reconnecting customers. This data may include information on agent availability, skills, and any prior interactions with the customer. By using this information, the queue management tool 704 can match reconnecting, and connecting, users with the best available agent. To illustrate, while N number of agents may have been connected to the central CC, M (where M<N) agents may be connected to the survivability CC 700. As such, the queue management tool 704 may optimize the allocation of available agents and queues to best match the queue positions of users at the central CC.

The queue evacuation tool 706 is configured to manage the transition of survivably queued user back to the central CC when it becomes available again. The queue evacuation tool 706 operates to dequeue end users who are currently queued at the survivability CC 700.

In some configurations of the contact center service, and as further described herein, it may be possible to seamlessly reconfigure a connection between a user device and the survivability CC 700 to be a connection between the user device and the central CC. In such a case, the queued user may experience no more than an interruption or a change to any hold music. In some other configurations of the contact center service, and as further described herein, it may not be possible to seamlessly reconnect a queued user to the central CC. In such cases, the queue evacuation tool 706 may notify queued customers that their connections need to be reestablished. To illustrate, a user may be notified with a message that essentially states, “We must call you back. You're position in the queue will be retained.”

In an example, a connection between a survivably queued user and the survivability CC 700 may be disconnected, and the end user device may receive a call from the central CC to reestablish the connection. In an example, once the queue evacuation tool 706 disconnects a connection with an end user, the queue evacuation tool 706 may transmit a notification to the central CC of the disconnection. The central CC, in response to the notification, may initiate an outbound call to the end user using a user identifier (e.g., a telephone number).

In another example, the end user may be directed (e.g., prompted) to reconnect to the contact center service. To illustrate, a user may be notified with a message that essentially states, “Please call back. You're position in the queue will be retained.”

To facilitate an efficient reconnection process, the queue evacuation tool 706 may provide each queued customer with a unique identification code. These codes serve as a reference for their queue positions. When customers reconnect to the central CC, they provide these codes, which are then used by the central CC to accurately place them back in the appropriate position in the queue. The survivability CC 700 transmits these codes and associated queue data to the central CC.

The agent device reconnecting tool 708 ensures that agents are effectively transitioned to the appropriate system during survivability (e.g., failover) and normal (e.g., failback) modes. The agent device reconnecting tool 708 may be configured with a list of agents or agent devices designated to be available in survivability mode. When the survivability CC 700 determines that it has become active, such as when the central CC is determined to be unavailable, the agent device reconnecting tool 708 transmits reconnection requests to these agent devices. In an example, when an agent device receives a notification to connect to the survivability CC 700, a notification may be presented at the agent device directing the agent to log onto the survivability CC 700.

Upon determining that the central CC is available again, the agent device reconnecting tool 708 may be configured to manage the orderly reconnection of agent devices back to the central CC. The agent device reconnecting tool 708 may transmit reconnection requests specifically to the devices of unengaged agents. Engaged agents carry out their respective engagements to completion before being transitioned back to the central CC thereby minimizing disruption to ongoing customer interactions, maintaining service continuity, and reducing customer wait times.

The agent device reconnecting tool 708 may transmit automated notifications to agents about the transition process, providing them with instructions and updates to ensure they are informed and prepared for the reconnection.

The end-user reconnecting tool 710 can be configured to facilitate the reconnection of end users during and/or after a transition to the survivability mode. Depending on the configuration of the contact center service, the end-user reconnecting tool 710 may utilize call-back functionality from the survivability CC 700 to get an end user back on the telephone line (e.g., to reconnect the end user), and to place them at an appropriate position in the queue upon reconnection. In an example, detection of survivability mode triggers an automatic outbound call-back, leveraging the synchronized the data received from the central CC to determine which end users are to be called back. If there are not enough agents available for each call-back, the end-user reconnecting tool 710 can requeue reconnected end users with prioritized placement in the queue.

In response to receiving a contact center request, the survivability CC 700 first determines whether the call is from a disconnected end user who was either engaged or queued at the time the central CC became unavailable. If the caller is identified as such, the queue management tool 704 is used to place the end user at an appropriate position in the queue. This ensures that the wait time and service priority of the end user are maintained, minimizing any disruption to their service experience. In an example, only contact center requests received within a configured threshold time (e.g., 10 minutes) of entering survivability mode are checked for whether they are from disconnected customers.

In an example, instead of or in addition to initiating outbound calls, the end-user reconnecting tool 710 may send automated notifications to end users informing them of the reconnection process. For example, the end-user reconnecting tool 710 may transmit notifications (e.g., email messages or Short Message Service (SMS) messages) to end users notifying them that they will receive call-backs shortly or provide them instructions on how to call back.

The reporting tool 712 provides detailed analytics and reporting on various aspects of the contact center service during survivability mode. The reporting tool 712 collects data on engagement durations, queue statuses, wait times, and agent performance. The reporting tool 712 also captures abandonment data related to contact center requests initiated during the normal mode but couldn't be reestablished in the survivability mode, such as because end users did not call back or could not be contacted. Upon re-establishing the normal mode, the survivability CC 700 transfers this data to the central CC. The transfer ensures that the central CC has a complete record of all activities that occurred during the survivability mode, allowing for accurate performance assessments and comprehensive service analytics. This data transfer includes timestamps of call activities, queue management details, and any agent notes or customer feedback collected during the period.

FIG. 7B is a block diagram of example functionality of central CC 750, which may be, for example, central CC 504 of FIG. 5. The central CC750 includes tools, such as programs, subprograms, functions, routines, subroutines, operations, executable instructions, and/or the like for, inter alia and as further described below, facilitating transitioning centrally queued or engaged users to become survivably queued or engaged users when the central CC 750 becomes unavailable and to facilitate transitioning survivably queued users to become centrally queued user when the central CC 750 is determined to be available again.

At least some of the tools of central CC 750 can be implemented as respective software programs that may be executed by one or more computing devices, such as the computing device 200 of FIG. 2. A software program can include machine-readable instructions that may be stored in a memory such as the memory 204, and that, when executed by a processor, such as processor 202, may cause the computing device to perform the instructions of the software program.

As shown, the central CC 750 includes a synchronization tool 752, a queue management tool 754, an end-user reconnecting tool 756, and a reporting tool 758. In some implementations, the central CC 750 can include more or fewer tools. In some implementations, some of the tools may be combined, some of the tools may be split into more tools, or a combination thereof.

The synchronization tool 752 facilitates data consistency between the central CC 750 and the survivability CC 700. The synchronization tool 752 continuously transmits workflow-related data, queue-related data, and customer interaction data to the survivability CC. Upon the central CC 750 becoming available, the synchronization tool 752 receives data from data from the survivability CC usable, such as by the queue management tool 754, to reconstitute survivably queued users as centrally queued users.

The queue management tool 754 operates to reconstitute end user queues when the contact center service transitions from the survivability mode to the normal mode. The queue management tool 754 uses data received from the survivability CC to determine the appropriate positions for reconnecting end users in the queue. The queue management tool 754 ensures that reconnecting end users maintain their priority and service continuity. The queue management tool 754 also identifies the most suitable agents for handling end user interactions based on agent availability, skills, and prior interactions.

The end-user reconnecting tool 756 facilitates the reconnection of end users after a transition from the survivability mode back to the normal mode. The end-user reconnecting tool 756 may use call-back functionality to reconnect end users and place them in the appropriate queue positions. The end-user reconnecting tool 756 leverages data received from the survivability CC to determine which users need to be called back and ensures that they are reconnected to the contact center service with minimal disruption. The end-user reconnecting tool 756 may be configured to send automated notifications to end users, informing them of the reconnection process and providing instructions on how to reconnect.

The reporting tool 758 is configured to provide detailed analytics and reporting on the performance of the contact center service during both normal and survivability operations. The reporting tool 758 collects data on queue statuses, wait times, agent performance, and overall service efficiency. This tool generates, based on data collected by the reporting tool 758 and reporting data received from the reporting tool 712 of the survivability CC 700, comprehensive reports that help contact center managers evaluate the effectiveness of the contact center, identify areas for improvement, and optimize operations. By providing insights into key performance metrics, the reporting tool 758 enables managers to maintain high service levels and ensure customer satisfaction. The reporting tool 758 also captures abandonment data related to calls initiated during survivability mode but couldn't be reestablished in the normal mode, such as because end users did not call back or could not be contacted.

The reporting tool 712 may, for example, capture and aggregate data related to caller engagement across the different operational modes. To illustrate, consider an end user, who was initially queued during normal operation, experienced a system failure (e.g., unavailability of the central CC), and was subsequently re-queued in the survivability mode. The reporting tool 712 collects and combines data from these different stages to generate comprehensive reports. This includes aggregating hold times from normal operation, survivability mode, and the re-queued period after the failure. By summing these distinct hold times, the reporting tool 712 provides a complete view of an end user's total hold time, ensuring accurate and detailed reporting on the caller's engagement and experience. This aggregated data may be useful, for example, for performance evaluations, enabling the contact center to assess and improve its service continuity and response strategies.

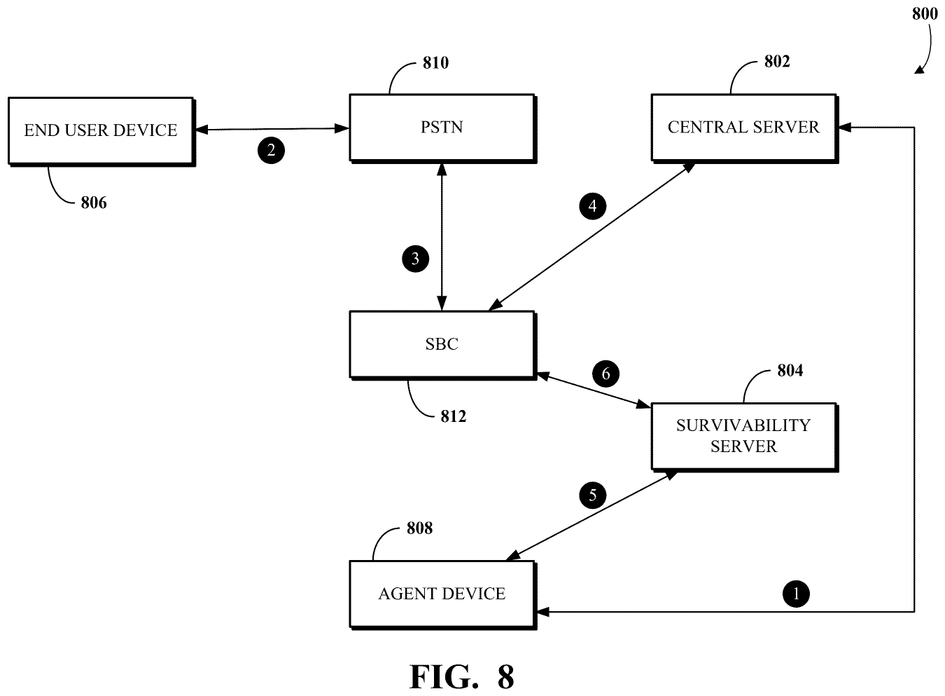

FIG. 8 is a block diagram 800 that illustrates an example of reconnecting a call from a central server 802, such as the central server 502 of FIG. 5, to a survivability server 804, such as the survivability server 506 of FIG. 5, in a contact center service. The block diagram 800 includes the central server 802, the survivability server 804, an end user device 806, an agent device 808, a PSTN 810, and an SBC 812.

In the normal mode of the contact center service, the agent device 808 connects (indicated by arrow (1)) to central server 802. How the agent device 808 connects to the central server 802 is further described below. The end user device 806 may initiate a call (e.g., a contact center request) that is routed through the PSTN 810 and the SBC 812 to the central server 802. The connection between the end user device 806 and the PSTN is indicated by arrow (2). The PSTN 810 handles the call from the end user device 806 and routes it (indicated by arrow (3)) to the SBC 812. The central server 802 manages the contact center services under normal conditions. The central server 802 receives the call routed (indicated by arrow (4)) through the SBC. The central server 802 also synchronizes data with the survivability server to ensure that the latter can take over seamlessly in the survivability mode (e.g., when the central server 802 is determined to be unavailable).

The SBC 812 manages the call routing between the end user device 806, the PSTN 810, the central server 802, and the survivability server 804. When the central server 802 becomes unavailable, the SBC 812 reroutes the call to the survivability server 804 (as indicated by arrow (5)). The SBC 812 can ensure that the call continuity is maintained by re-establishing the call with the survivability server 804 (as indicated by arrow (6)). The agent device 808 is used by the contact center agent to handle the call. In the normal mode, the call is routed from the central server 802 to the agent device. In the survivability mode, the agent device 808 is connected to the survivability server 804.

To restate, when the end user device 806 initiates a call, the call is routed through the PSTN 810 and the SBC 812 to the central server 802. The central server 802 handles the call and directs it to the agent device 808. The SBC 812 may continuously monitor the connection to the central server 802. If the SBC 812 detects that the connection to the central server 802 has failed, such as due to a network outage or server failure, it may initiate a failover process. In another example, the SBC 812 may receive, such as from the survivability server 804, a command to initiate the failover process to enter the survivability mode. In this process, the SBC 812 reroutes the call from the central server 802 to the survivability server 804, which has been receiving synchronized data from the central server 802 and thus takes over call and queue management. The agent device 808, which was initially connected to the central server 802, may then reconnect to the survivability server 804 and continue handling the call with minimal disruption.

The SBC 812 may cause a connection (e.g., a session) between the end user device 806 and the central server 802 to become a connection between the end user device 806 and the survivability server 804 using SIP Re-INVITE. The SBC 812 can initiate a new SIP INVITE request to the survivability server 804, using the same call identifiers and session parameters as the original call. The survivability server 804, having received synchronized data from the central server, is prepared to handle the call and responds with a SIP 200 OK message. The SBC 812 forwards the SIP 200 OK response from the survivability server 804 to the end user device 806, completing the new SIP session setup. The SBC 812 can perform a similar process to cause a connection (e.g., a session) between the end user device 806 and the survivability server 804 to become a connection between the end user device 806 and the central server 802.

How the agent device 808 connects to the central server 802 is now described. An agent application executing at the agent device 808, when launched, causes the agent device 808 to connect to the central server 802 over the internet. During this connection, the central server 802 identifies that the user associated with the agent device 808 is a contact center-enabled agent and informs the application to retrieve a respective contact center configuration. The agent application then initiates a web connection to the central server 802 to obtain information such as queue assignments, policies, and other contact center-specific details. This information includes configurations necessary for handling PSTN calls. With this configuration data, the agent device establishes a SIP-based connection to a designated regional data center, which manages the PSTN services.

If the connection to the central server 802 is disrupted, the agent application may use built-in mechanisms to maintain call continuity. For example, upon determining that the central server 802 is unavailable, the agent device 808 may re-register to the survivability server 804 via SIP communication, thereby ensuring that it transitions from the normal model to the survivability mode. This process ensures that the agent device 808 remains connected and operational, providing continuous service to the end user.

When the central server 802 becomes available again, the agent device 808 may receive a command (such as from the central server 802 or the survivability server 804) to perform a similar process as that described above to re-register to the central server 802. In another example, the agent device 808 may include validation capabilities whereby the agent device 808 need not receive a command to re-register. The agent device 808 may be configured to automatically attempt connectivity (e.g., reconnect) to another server (e.g., the survivability server 804 or the central server 802) when a server (e.g., the central server 802 or the survivability server 804) that the agent device 808 is currently connected to is no longer available.

The block diagram 800 illustrates a configuration where the PSTN 810 is said to pass through the SBC 812, which may be deployed on-premises. In another configuration, the contact center service may implement or work in conjunction with what is referred to as carrier platform. With a carrier platform, PSTN and PBX services are provided by the carrier platform and need not be separately provided or acquired by a customer.

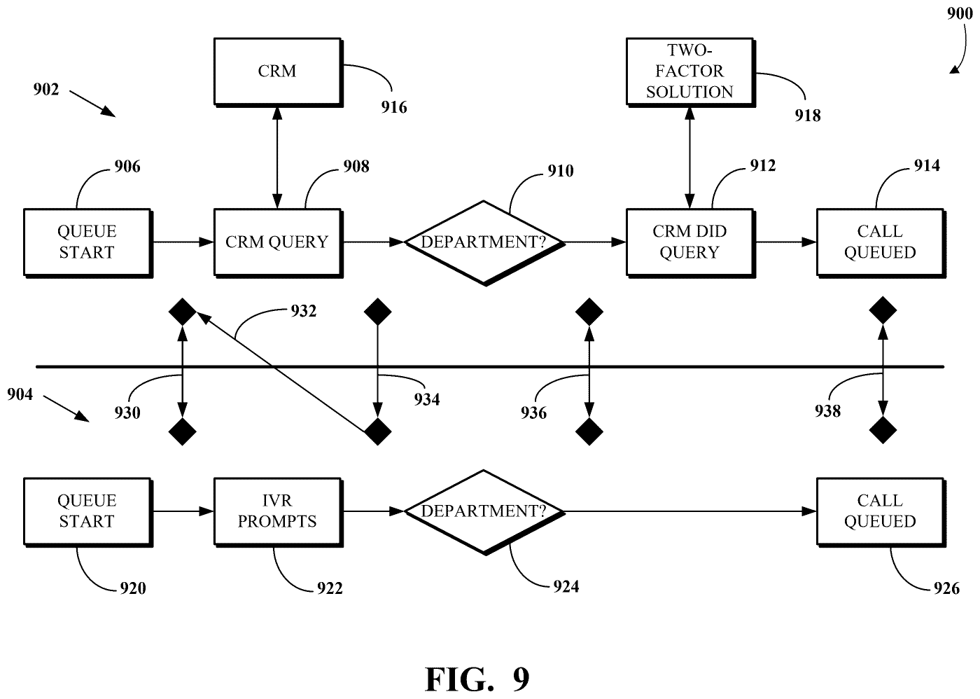

FIG. 9 illustrates an example 900 a mapping between a central workflow 902 of a central CC and a survivability workflow 904 of a survivability CC. As mentioned above, the central CC may include advanced call routing, customer data integration, and other integrations that may not be available at the survivability CC. It is noted that the disclosure herein is not limited to by the central workflow 902 or the survivability workflow 904. These workflow are merely used to explain the concepts workflow mappings usable in transitioning a contact center service between normal and survivability modes.

The central workflow 902 includes steps 906-914, and the survivability workflow 904 includes steps 920-926. The mappings between the central workflow 902 and the survivability workflow 904 are indicated by mappings 930-938. The mappings can be represented by any suitable data structure and stored at or are accessible by the central CC and the survivability CC.

In the central workflow 902, the process begins (e.g., is triggered or instantiated) at the step 906 when a contact center request is received. A the step 908, the central CC queries a CRM system 916 using an identifier (e.g., a telephone number) associated with the contact center request to obtain data related to the calling end user. For example, the data received from the CRM system 916 may indicate that the end user is associated with prioritized routing. At a step 910, the end user may be prompted for the department (e.g., a queue or group of agents) to route the contact center request to. For example, the end user may be prompted to “press 1 to pay a bill or 2 to request service.” At 912, the workflow 902 may trigger a two-factor authentication process to verify the identity of the end user. The two-factor authentication process may be performed by a two-factor solution 918 to verify the identity of the end user (e.g., the caller) before queuing the call, at step 814.

In contrast, the survivability workflow 904 operates with a reduced set of functionalities due, for example, to a lack of access to the CRM system 916 or the two-factor solution 918. For example, the survivability CC may not include necessary application integration keys to be able to use these systems. The survivability workflow 904 starts at step 920 with the queue initiation, followed by IVR prompts at step 922, to collect some information about the end user. At step 924 the callers may be asked to select options like “press 1 to pay a bill or 2 to request service.” The step 924 determines the appropriate department (e.g., queue or group of agents), and the call is queued at step 926. This simpler process ensures basic call routing and handling capabilities even when the advanced features of the central CC are unavailable.

The mappings 930-938 illustrate the transition and synchronization of data between the central workflow 902 and survivability workflow 904. A mapping between a first location within a first workflow of a first contact center and a second location within a second workflow of a second contact center indicates that if the workflow-data indicates that the first workflow was at the first location with respect to an end user (e.g., with respect to a contact center request), then when the end user is reconnected at the second contact center, then the second workflow should be executed (e.g., instantiated) so at to be automatically advanced to the second location.

The mapping 930 indicates that if the central workflow 902 were prior to the step 908, then the survivability workflow 904 should be advanced to before the step 922; and that if the survivability workflow 904 were prior to the step 922, then the central workflow 902 should be advanced to before the step 908. The mapping 932 indicates that if the survivability workflow 904 were between the steps 922 and 924, then the central workflow 902 should be advanced to before the step 908 so that the step 908 can be performed with respect to the end user that is reconnected at the central CC. The mapping 934 indicates that if the central workflow 902 were prior to the step 910, then the survivability workflow 904 should be advanced to before the step 924.

The mapping 936 indicates that if the central workflow 902 were at any step between the steps 910 and 914, then the survivability workflow 904 is advanced to after the step 924; and if the survivability workflow 904 were past the step 924, then the central workflow 902 is advanced to before the step 912. The mapping 928 indicates that the steps 924 and 926 map to each other.

These mappings can be used when transitioning between the normal mode to the survivability mode to properly queue reconnected end users. The mapping can be used, in conjunction with workflow-related data (transmitted from the normal CC to the survivability CC or vice versa) to correctly route and handle the reconnected contact center requests based on the information available at the time of the failover (or failback). With respect to a contact center request that is not yet queued (e.g., that is still being processed through a routing workflow to identify a queue or agent appropriate for to handle the contact center request), the workflow-related data includes an identifier of the routing workflow and the last step of the routing workflow that is executed.

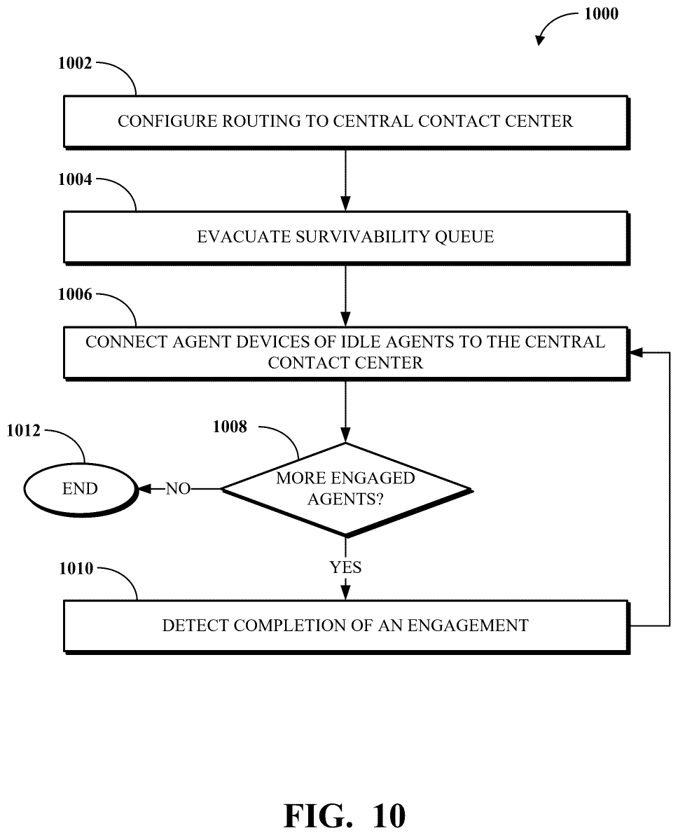

To further describe some implementations in greater detail, reference is next made to examples of techniques which may be performed by or using a system for transitioning a contact center service between normal and survivability modes. FIG. 10 is a flowchart of an example of a technique 1000 for transitioning agents from survivability mode to normal mode. The technique 1000 can be executed using computing devices, such as the systems, hardware, and software described with respect to FIGS. 1-9. The technique 1000 can be performed, for example, by executing a machine-readable program or other computer-executable instructions, such as routines, instructions, programs, or other code. The steps, or operations, of the technique 1000, or another technique, method, process, or algorithm described in connection with the implementations disclosed herein can be implemented directly in hardware, firmware, software executed by hardware, circuitry, or a combination thereof.

The technique 1000 is executed to transition agents and call handling from the survivability mode of a contact center service back to the normal mode when the central CC is determined to be available again. Call routing is configured to direct incoming calls to the central CC. The existing survivability queue is evacuated by transferring on-hold (e.g., queued) end users to the central CC while preserving their queue positions. Idle agents are reconnected to the central CC to manage incoming contact center requests (e.g., calls), while actively engaged agents complete their current engagements before transitioning. The termination of engagements is continuously monitored to reconnect agents to the central CC, thus ensuring an organized and efficient restoration of full contact center functionality. After all engagements are completed at the survivability CC, the survivability CC returns to a stand by mode.

At 1002, contact center requests are configured to be routed to the central CC. For example, a command may be transmitted to an SBC, such as the SBC 812 of FIG. 8, to configure the SBC to direct incoming calls to the central server instead of the survivability server. In an example, the survivability server may transmit the command. In an example, the central server may transmit the command. In an example, the command may be transmitted in response to an authorized person causing the command to be transmitted, such via a user interface associated with the SBC or the contact center service. For example, the authorized person may access call routing configuration settings associated with the contact center service to cause the command to be transmitted. Routing rules can be updated to redirect incoming calls (e.g., contact center requests) from the survivability server to the central contact center. This may involve modifying SIP routing tables, updating Domain Name System (DNS) entries, or adjusting configuration settings in the SBC.

At 1004, the survivability queue is evacuated. Users who are currently on hold in the survivability queue are transferred to the central CC. The transfer process ensures that the queue details are preserved and that callers are reconnected to the central CC, maintaining their position in the queue. That is, the survivably queued users are transitioned to be centrally queued users. Queue-related data, workflow-related data, and user-related data are transmitted from the survivability server to the central CC, as described above.

In some implementations, for a contact center request that is currently queued in or at the survivability CC, a SIP re-INVITE message can be sent to renegotiate the media path, transitioning the call handling from the survivability server to the central CC. A SIP transfer operation may be performed by, for example, sending a SIP REFER message to the end user device, instructing the end user device to re-establish the call with the central CC. The central contact center then sends a SIP INVITE to the end user device to complete the transfer.

In some implementations, notifications may be sent to end users in the survivability queue, informing them of the transition. Messages that essentially state, “we must reconnect you to our main system” are provided to keep callers informed and reassured.

At 1006, agent devices of idle agents are connected to the central CC. Idle agents, who are not currently engaged in active calls with end users, are reconnected to the central CC to handle incoming contact center requests or requeued contact center requests.

At 1008, the technique 1000 determines whether there are more engaged agents at the survivability CC. If so, the technique 1000 proceeds to 1010; otherwise, the technique 1000 ends at 1012. At 1010, the technique 1000 detects (e.g., monitors for) the completion of an engagement. That is, the technique 1000 detects that one or more agents are now idle. When an agent becomes idle, the technique 1000 returns to 1006 to cause the agent device of the idle agent to be connected to the central CC.

FIG. 11 is an example of a technique 1100 for contact center workflow mapping in survivability mode. The technique 1100 can be executed using computing devices, such as the systems, hardware, and software described with respect to FIGS. 1-9. The technique 1100 can be performed, for example, by executing a machine-readable program or other computer-executable instructions, such as routines, instructions, programs, or other code. The steps, or operations, of the technique 1100, or another technique, method, process, or algorithm described in connection with the implementations disclosed herein can be implemented directly in hardware, firmware, software executed by hardware, circuitry, or a combination thereof. The technique 1100 can be implemented by a survivability CC or a survivability server associated with a contact center service, such as those described herein.

At 1102, data associated with a first workflow executed by a central server with respect to an end user connected to contact center service via the central server is received. That the user is connected to the contact center service includes that a device of the user is connected to the contact center service. For example, data associated with a first workflow executed by a central server with respect to a contact center request received from the end user is received. The data can be or include the one or more of workflow-related data, queue-related data, and/or customer interaction data, as described herein.

At 1104, the survivability server determines that the central server is unavailable. The central server can be determined to be unavailable in any number of ways. For example, the survivability server may detect an absence of heartbeat signals from the central server for a predefined period of time. For example, the survivability server may transmit ping requests to the central server and detect a failure to receive responses to the ping requests from the central server. For example, the survivability server may receive an explicit message from the central server indicating that the central server is unavailable.

In response to determining that the central server is unavailable, the contact center service enters survivability mode. Accordingly, at 1106, a second workflow to be executed by the survivability server is identified. The second workflow is identified based on the data received from the central server. The second workflow may be identified based on a mapping that associates the second workflow with the first workflow. In an example, the survivability server transmits a notification to a device of the end user indicating the unavailability of the central server. In an example, the survivability server initiates an outbound call to a device of the end user.

At 1108, the second workflow is executed with respect to the end user. Executing the second workflow includes advancing the workflow to a step identified by the mapping. Advancing the workflow past certain steps means not to carry out (e.g., execute) those certain steps. As such, a last completed step of the first workflow may be identified based on the data received from the central server and a step of a second step of the second workflow is identified for execution, such as based on the mapping.

In an example, the second workflow may include a step for collecting data from the end user. The data obtained from the user can be used to identify a queue to place the end user in. In another example, the data received from the central server may be used to place the end user in a queue based on the data. In an example, the data received from the central server may include data obtained from the end user by the first workflow and/or data obtained about the end user by the first workflow. When an agent is engaged with the end user via the survivability server, such data can be presented (e.g., displayed) to the agent at the agent device. When the central server is determined to be available again, the survivability server transmits to the central server data related to end users queued at the survivability server. For an end user queued at the survivability server, when the central server becomes available again, a notification may be sent to that end user indicating that the end user is to be recontacted based on the central server becoming available again. In an example, the end user is placed in a queue at a first position that is based on a second position of the end user at the central server.

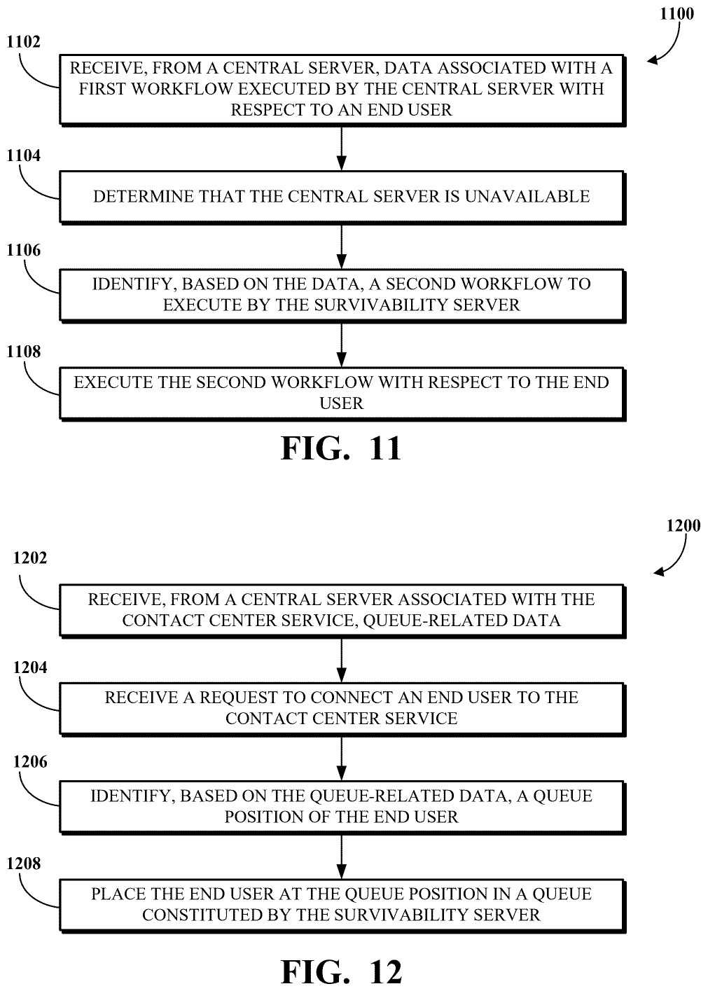

FIG. 12 is an example of a technique 1200 for queue management in a contact center service during survivability mode. The technique 1200 can be executed using computing devices, such as the systems, hardware, and software described with respect to FIGS. 1-9. The technique 1200 can be performed, for example, by executing a machine-readable program or other computer-executable instructions, such as routines, instructions, programs, or other code. The steps, or operations, of the technique 1200, or another technique, method, process, or algorithm described in connection with the implementations disclosed herein can be implemented directly in hardware, firmware, software executed by hardware, circuitry, or a combination thereof. The technique 1200 can be implemented by a survivability CC or a survivability server associated with a contact center service, such as those described herein.

At 1202, queue-related data is received from a central server associated with the contact center service. The queue-related data can include information about the queue positions of end users queued at the central server. The queue-related data may additionally include data relating to end users currently engaged with agents via the central server. Additional data may also be received from the central server such as priority levels and historical interaction data with the contact center service. The survivability server may receive updates to the queue-related data from the central server.

At 1204, the survivability server receives a request to connect an end user to the contact center service. This request can be initiated by the end user through various communication channels, such as telephony, video, text messaging, chat, or social media. In an example, when receiving the request to connect the end user to the contact center service, the technique 1200 may involve identifying contact information (e.g., an email address or telephone number) associated with the end user. A connection request may be initiated with the end user based on (e.g., using) the contact information. When the survivability server connects with the end user (e.g., with a device of the end user), then the request to connect the end user to the contact center service is considered (e.g., determined to be) received. In an example, an outbound call may be initiated to the end user in response to determining that the central server is unavailable.

At 1206, the survivability server identifies a queue position of the end user based on the queue-related data received from the central server. This identification process involves analyzing the data to determine the most appropriate position for the end user in the queue. Such an analysis includes determining the number of available agents at the survivability server. The position of the end user in the queue can be based on whether the queue-related data indicates that the end user is associated with prioritized routing.

At 1208, the end user is placed at the identified queue position in a queue constituted by the survivability server. The queue position is adjusted to ensure that the end user receives the appropriate level of service based on their priority and the available agents. As described above, the end user's position in the queue is maintained accurately during the transition to survivability mode thereby providing seamless continuity in the contact center service. The queue can be identified from amongst multiple queues based on the queue-related data, ensuring, for example, that the end user is placed in the most appropriate queue for their needs.

In some implementations, placing the end user at the queue position in the queue constituted by the survivability server includes determining, based on the queue-related data, that the end user is associated with priority routing and placing the end user at the front of the queue.

In some implementations, a request to connect another end user to the contact center service may be received. The technique 1200 determines whether the queue-related data includes data related to the another end user. If not, the another end user is placed at the tail of the queue. That is, if the another end user is not one that was connected to the central server and is now being reconnected to the contact center service in survivability mode, and assuming that the another user is not associated with prioritized routing, then the another end user is placed at the tail of the queue (or more generally later in the queue that the end user).

In some implementations, the technique 1200 may include determining, based on the queue-related data, a priority level associated with the end user and adjusting a position of the end user in the queue based on the priority level.

When the end user is reconnected to the contact center service, the survivability server may inform the end user of an estimated wait time. The estimated wait time may be determined based on analyzing the queue-related data to predict wait times.

The technique 1200 may also log data related to the queue position and a wait time. When it is determined that the central server is available again, the logged data is transmitted to the central server.

In an example, in response to determining that the central server is available again, the end user is notified that their current connection with the contact center service will terminate and that the end user will receive a connection request from the contact center service. In another example, in response to determining that the central server is available again, the end user is notified to reconnect to the contact center service. In either case, the notification may indicate that the position of the end user in the queue will be preserved.

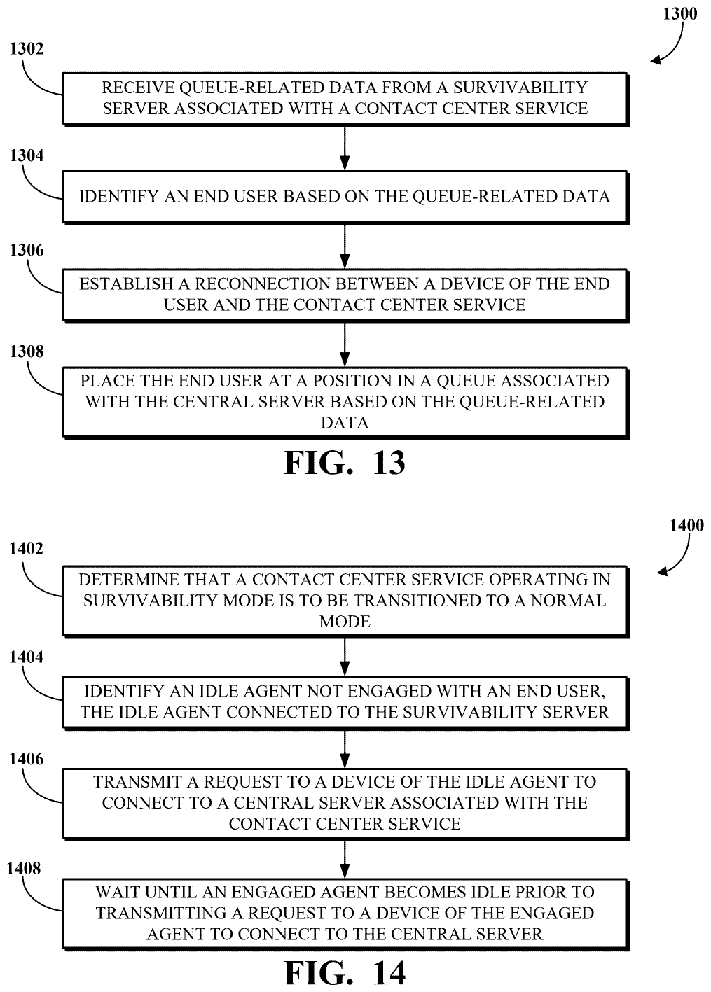

FIG. 13 is an example of a technique 1300 for transitioning queue management from a survivability server back to a central server in a contact center service. The technique 1300 can be executed using computing devices, such as the systems, hardware, and software described with respect to FIGS. 1-9. The technique 1300 can be performed, for example, by executing a machine-readable program or other computer-executable instructions, such as routines, instructions, programs, or other code. The steps, or operations, of the technique 1300, or another technique, method, process, or algorithm described in connection with the implementations disclosed herein can be implemented directly in hardware, firmware, software executed by hardware, circuitry, or a combination thereof. The technique 1300 can be implemented by a central CC server, such as one of the central CC servers described herein.

At 1302, queue-related data is received from a survivability server associated with the contact center service. This queue-related data can include information about the queue positions of end users queued at the survivability server.

At 1304, the central server identifies an end user based on the queue-related data. The identification process involves analyzing the queue-related data to determine the end user's position and any associated priority information. For instance, the central server may determine that the queue-related data indicates the end user is associated with prioritized routing.

At 1306, the central server establishes a reconnection between a device of the end user and the contact center service. Establishing the connection can include sending a SIP re-invite message to the device of the end user to modify a first connection between the device of the end user and the survivability server to become a second connection between the device of the end user and the central server. In an example, the end user may be notified of the reconnection event by the central server. In another example, the notification may be transmitted by the survivability server. In an example, the reconnection process can also involve receiving a contact center request from the device of the end user and determining that the queue-related data includes data related to the end user. The reconnection can be established based on the determination. The central server can also log data related to the queue position and wait time during this process, ensuring that all actions are recorded for quality assurance purposes.

At 1308, the central server places the reconnected end user at a position in a queue associated with the central server based on the queue-related data. This placement ensures that the end user retains their relative position and priority level within the queue. The queue-related data may include information on whether the queue includes another end user, and the central server may determine whether to place the reconnected end user ahead of the another end user based on whether the queue-related data includes data related to the another end user.

The central server may also handle new end user contact center requests. For example, the central server may receive a contact center request from a new end user and place the new end user at the tail of the queue if the queue-related data does not include data related to the new end user. The new user is placed at the tail of the queue if the end user is not associated with prioritized routing. That is, the position of the new end user in the queue can be determined based on whether the new end user is associated with prioritized routing. The end user is placed at the tail of the queue in the situation that the contact center request received from the new user is the latest received contact center request. If not, and more generally, the new user is placed later in the queue than the end user.

The technique 1300 can include transmitting an indication to the survivability server that the contact center service is transitioning from a survivability mode to a normal mode. The queue-related data is then received based on this indication. That is, the survivability server transmits the queue-related data in response to receiving the indication.

FIG. 14 is an example of a technique 1400 for transitioning a contact center service from survivability mode back to normal mode. The technique 1400 can be executed using computing devices, such as the systems, hardware, and software described with respect to FIGS. 1-9. The technique 1400 can be performed, for example, by executing a machine-readable program or other computer-executable instructions, such as routines, instructions, programs, or other code. The steps, or operations, of the technique 1400, or another technique, method, process, or algorithm described in connection with the implementations disclosed herein can be implemented directly in hardware, firmware, software executed by hardware, circuitry, or a combination thereof. The technique 1400 can be implemented by a survivability server associated with a contact center service, such one of the survivability servers described herein.

At 1402, the survivability server determines that a contact center service operating in survivability mode is transitioned to a normal mode. This determination can be made based on an indication received from the central server indicating that the central server is now available. At 1404, the survivability server identifies an idle agent. An idle agent is one connected to the survivability server and not currently engaged with an end user. Identifying the idle agent can involve querying a data store that stores agent status information and selecting an agent whose status is marked as idle. In an example, the survivability server may transmit an alert to the idle agent indicating that the contact center service will be transitioned to normal mode.

At 1406, the survivability server transmits a request to a device of the idle agent to connect to the central server associated with the contact center service. At 1408, the survivability server waits until an engaged agent becomes idle before transmitting a request to a device of the engaged agent to connect to the central server. This process ensures a smooth transition without disrupting ongoing engagement between agents and end users.

The survivability server may transmit, to the central server, queue-related data indicating queued end users at the survivability server. This queue-related data can include information on the positions of end users in the queue, their priority levels, and any historical interaction data with the contact center service. The central server restores the queued end users into a queue associated with the central server based on the received queue-related data.

The survivability server may stop connecting queued end users to agents at the survivability server based on the determination that the contact center service is transitioned to the normal mode. That is, even though end users may be in the queue at the survivability server, those end users will not be connected to agents connected to the survivability server.

The survivability server may transmit data related to contact center requests received at the survivability server while the contact center service was in survivability mode. This data can be used by the central server to update its records and maintain accurate logs of all interactions.

For simplicity of explanation, the techniques 1000-1400 of FIGS. 10-14, respectively, are each depicted and described herein as a respective series of steps or operations. However, the steps or operations of each of the techniques 1000-1400 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method performed by a survivability server associated with a contact center service. The method includes determining that the contact center service operating in survivability mode is transitioned to a normal mode; identifying an idle agent not engaged with an end user, the idle agent connected to the survivability server; transmitting a request to a device of the idle agent to connect to a central server associated with the contact center service; identifying an engaged agent; and waiting until the engaged agent becomes idle prior to transmitting a request to a device of the engaged agent to connect to the central server. Implementations may include one or more of the following features.

The method may include transmitting, to the central server, queue-related data indicating queued end users at the survivability server. The central server may restore the queued end users into a queue associated with the central server based on the queue.

The method may include stop connecting queued end users to agents at the survivability server based on determining that the contact center service is transitioned to the normal mode.

The method where determining that the contact center service operating in the survivability mode is transitioned to the normal mode may include receiving an indication from the central server indicating that the contact center service is transitioned to the normal mode.

The method may include transmitting, to the central server, data related to contact center requests received at the survivability server while the contact center service is in the survivability mode.

The method may include transmitting an alert to the idle agent indicating that the contact center service will be transitioned to normal mode.

The method where identifying the idle agent may include querying a data store storing agent status information; and selecting an agent whose status is marked as idle.

One general aspect is a system that includes one or more memories and one or more processors. The one or more processors configured to execute instructions of a survivability server associated with a contact center service and stored in the one or more memories to determine that the contact center service operating in survivability mode is transitioned to a normal mode; identify an idle agent not engaged with an end user, the idle agent connected to the survivability server; transmit a request to a device of the idle agent to connect to a central server associated with the contact center service; identify an engaged agent; and wait until the engaged agent becomes idle prior to transmitting a request to a device of the engaged agent to connect to the central server.

Implementations may include one or more of the following features.

The system where the one or more processors may be configured to execute instructions stored in the one or more memories to transmit, to the central server, data collected from queued end users at the survivability server.

The system where the one or more processors may be configured to execute instructions stored in the one or more memories to stop connecting queued end users to agents at the survivability server.

The system where the instructions to determine that the contact center service operating in the survivability mode is transitioned to the normal mode may include instructions to receive a request from the central server for queue-related data.

The system where the one or more processors may be configured to execute instructions stored in the one or more memories to transmit, to the central server, data related to contact center requests received at the survivability server while the contact center service is in the survivability mode.

The system where the instructions to wait until the engaged agent becomes idle may include instructions to query a data store storing agent status information to identify the idle agent.

One general aspect is one or more non-transitory computer readable media storing instructions operable to cause one or more processors to perform operations performed by a survivability server associated with a contact center service. The operations include determining that the contact center service operating in survivability mode is transitioned to a normal mode; identifying an idle agent not engaged with an end user, the idle agent connected to the survivability server; transmitting a request to a device of the idle agent to connect to a central server associated with the contact center service; identifying an engaged agent; and waiting until the engaged agent becomes idle prior to transmitting a request to a device of the engaged agent to connect to the central server.

Implementations may include one or more of the following features.

The one or more non-transitory computer readable media where the operations may include transmitting, to the central server, queue-related data indicating queued end users at the survivability server.

The one or more non-transitory computer readable media where the operations may include transmitting notifications to queued end users to reconnect to the contact center service.

The one or more non-transitory computer readable media where determining that the contact center service operating in the survivability mode is transitioned to the normal mode may be based on an indication received from the central server.

The one or more non-transitory computer readable media where the operations may include transmitting, to the central server, data related to contact center requests received at the survivability server while the contact center service is in the survivability mode.

The one or more non-transitory computer readable media where the idle agent may be identified based on a status associated with the idle agent in a data store.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random-access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively, or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method performed by a survivability server associated with a contact center service, comprising:
determining that the contact center service operating in survivability mode is transitioned to a normal mode;
identifying an idle agent not engaged with an end user, the idle agent connected to the survivability server;
transmitting a request to a device of the idle agent to connect to a central server associated with the contact center service;
identifying an engaged agent; and
waiting until the engaged agent becomes idle prior to transmitting a request to a device of the engaged agent to connect to the central server.

2. The method of claim 1, further comprising:
transmitting, to the central server, queue-related data indicating queued end users at the survivability server.

3. The method of claim 2, wherein the central server restores the queued end users into a queue associated with the central server based on the queue.

4. The method of claim 1, further comprising:
stop connecting queued end users to agents at the survivability server based on determining that the contact center service is transitioned to the normal mode.

5. The method of claim 1, wherein determining that the contact center service operating in the survivability mode is transitioned to the normal mode comprises:
receiving an indication from the central server indicating that the contact center service is transitioned to the normal mode.

6. The method of claim 1, further comprising:
transmitting, to the central server, data related to contact center requests received at the survivability server while the contact center service is in the survivability mode.

7. The method of claim 1, further comprising:
transmitting an alert to the idle agent indicating that the contact center service will be transitioned to normal mode.

8. The method of claim 1, wherein identifying the idle agent comprises:
querying a data store storing agent status information; and
selecting an agent whose status is marked as idle.

9. A system, comprising:
one or more memories; and
one or more processors, the one or more processors configured to execute instructions of a survivability server associated with a contact center service and stored in the one or more memories to:
determine that the contact center service operating in survivability mode is transitioned to a normal mode;
identify an idle agent not engaged with an end user, the idle agent connected to the survivability server;
transmit a request to a device of the idle agent to connect to a central server associated with the contact center service;
identify an engaged agent; and
wait until the engaged agent becomes idle prior to transmitting a request to a device of the engaged agent to connect to the central server.

10. The system of claim 9, wherein the one or more processors further configured to execute instructions stored in the one or more memories to:
transmit, to the central server, data collected from queued end users at the survivability server.

11. The system of claim 9, wherein the one or more processors further configured to execute instructions stored in the one or more memories to:
stop connecting queued end users to agents at the survivability server.

12. The system of claim 9, wherein the instructions to determine that the contact center service operating in the survivability mode is transitioned to the normal mode comprises instructions to:
receive a request from the central server for queue-related data.

13. The system of claim 9, wherein the one or more processors further configured to execute instructions stored in the one or more memories to:
transmit, to the central server, data related to contact center requests received at the survivability server while the contact center service is in the survivability mode.

14. The system of claim 9, wherein the instructions to wait until the engaged agent becomes idle comprise instructions to:
query a data store storing agent status information to identify the idle agent.

15. One or more non-transitory computer readable media storing instructions operable to cause one or more processors to perform operations performed by a survivability server associated with a contact center service, the operations comprising:
determining that the contact center service operating in survivability mode is transitioned to a normal mode;
identifying an idle agent not engaged with an end user, the idle agent connected to the survivability server;
transmitting a request to a device of the idle agent to connect to a central server associated with the contact center service;
identifying an engaged agent; and
waiting until the engaged agent becomes idle prior to transmitting a request to a device of the engaged agent to connect to the central server.

16. The one or more non-transitory computer readable media of claim 15, the operations further comprising:
transmitting, to the central server, queue-related data indicating queued end users at the survivability server.

17. The one or more non-transitory computer readable media of claim 15, the operations further comprising:
transmitting notifications to queued end users to reconnect to the contact center service.

18. The one or more non-transitory computer readable media of claim 15, wherein determining that the contact center service operating in the survivability mode is transitioned to the normal mode is based on an indication received from the central server.

19. The one or more non-transitory computer readable media of claim 15, the operations further comprising:
transmitting, to the central server, data related to contact center requests received at the survivability server while the contact center service is in the survivability mode.

20. The one or more non-transitory computer readable media of claim 15, wherein the idle agent is identified based on a status associated with the idle agent in a data store.
